(19) United States
(12) Patent Application Publication
(10) Pub. No.: US 2026/0245035 A1
(43) Pub. Date: Aug. 20, 2026

(54) REALOGRAM GENERATION FROM CROWDSOURCED INDOOR POSITIONING SYSTEM AND PRODUCT SCAN DATA

(71) Applicant: ORIIENT NEW MEDIA LTD., Tel Aviv (IL)

(72) Inventors: Amiram FRISH, Giv'atayim (IL); Zion REGEV, Tel Aviv Yafo (IL)

(21) Appl. No.: 18/992,655

(22) PCT Filed: Jun. 25, 2023
(86) PCT No.: PCT/IB2023/056547

§ 371 Date: Jan. 9, 2025

Related U.S. Application Data
(60) Provisional application No. 63/368,065, filed on Jul. 11, 2022.

(51) Int. Cl. G06Q 10/087

(52) U.S. Cl. CPC G06Q 10/08724

(57) ABSTRACT

Methods and systems receive, for each mobile device of one or more mobile device, scan-location data that includes product scan data and associated location data for the mobile device. The product scan data is generated in response to scanning of a product by the mobile device, and the location data is indicative of a location of the mobile device at a time of the scanning of the product. The received scan-location data of the one or more mobile device is processed, by a computer processor, to produce a realogram of products scanned by the one or more mobile device.

### CROSS-REFERENCE TO RELATED APPLICATIONS

This application claims priority from U.S. Provisional Patent Application No. 63/368,065, filed Jul. 11, 2022, whose disclosure is incorporated by reference in its entirety herein.

### TECHNICAL FIELD

The present disclosure relates to planograms and indoor positioning systems, and in particular the generation of realograms from crowdsourced indoor positioning and product scans data.

### BACKGROUND OF THE INVENTION

Personal mobile devices provide a variety of services. One such service is shopping fulfillment or collection of goods in-store from an online order, where a shopper, a picker, or a store associate needs to find the goods in-store and collect them in a time-efficient manner. This service is typically offered today as part of mobile applications such as retail Scan & Go applications, grocery delivery applications, or in-store employees applications. The users of these applications typically perform product scanning as part of the application usage, to mark that a product was checked (picked/examined) usually in the vicinity of the product location in the store. Knowing where each product is located in the store is of great value for both the owner of these applications and the users of the applications.

Planograms are tools for visual merchandising in the form of diagrams or models that indicate where retail products are planned to be located and displayed in the store, for example on retail shelves or display cases. Some retail stores often have a planogram of the store, while other retailers do not. Even those who have a planogram find the planogram use to be limited in practice, as the locations of products in the store may change over the course of operation of the store for a variety of reasons, such that the actual location of products at a given time (referred to as a realogram) do not conform to the planned location.

A realogram may be used for a variety of purposes, including, for example, making products or retail items more easily locatable, validating placement of products against the planogram (planogram compliance), and even understanding when products are out-of-stock. However, maintaining an up-to-date realogram is a challenge for retailers. Some solutions rely on regular scanning of in-store products by automated or semi-automated devices such as robots, or even deploying arrays of fixed-position cameras throughout the store to monitor the products on the shelves. While these solutions may be advantageous and provide relatively accurate realograms, they can be prohibitively expensive.

### SUMMARY OF THE INVENTION

The present disclosed subject matter, also referred to herein as the disclosure, includes methods and systems that produce realograms that have realogram data descriptive of the actual location of products at a given time. The produced realograms, and realogram data thereof, are generated from product scan data that is generated by scanning of products in stores by mobile devices, and location data associated with the mobile devices performing the product scans. Aspects of the present disclosure provide methods and systems that utilize indoor positioning systems (IPS) location services to generate the location data for multiple mobile devices, in combination with scans of store products by mobile devices (e.g., in-application product scans) via, for example, barcode scans, QR scans, RFID scans, image recognition scans, and manually product identifier entry and the like, to produce up-to-date realograms from crowdsourced product scan data and associated location data.

As will be discussed, the realogram generation may depend on several factors, including the usage of the mobile device product scanning function and any associated scanning applications, the behavior of the users of the mobile devices themselves, the quality or accuracy of the IPS-generated location data, changes in the store (such as product changes, product placement changes, layout changes, etc.), and changes in the amount of traffic in the store. For example, a shopping list fulfillment application can provide each mobile device user with an online order, where some of the products are more popular than others, and thus the product scan data may not be uniformly distributed amongst the products (i.e., some of the products are scanned more often, e.g., several times a day, while other products are scanned less often, e.g., once a month). Furthermore, a product may be placed in multiple locations in a store (for example in a grocery store certain candy bars may be placed in multiple display racks or shelves located at or close to different check-out points, and may also be placed in the candy aisle), and one placement may be more popular than another. A user may also pick some products, take them to a different location, for example the location of the user's shopping cart, and only then scan the products, creating a displacement between the location of the scan and the location of the product on the shelf. In addition, in-store operation may change the location of products from time-to-time, for example moving products to a different display (e.g., a front display), switching shelves, or even rearranging entire departments. Moreover, a single product may be placed at multiple locations, i.e., multi-location or multi-placement. Also, from time-to-time new products may be inserted to the store catalog and others removed. Furthermore, the IPS may provide location data that differs in quality throughout the store. For example, sometimes the location data of a mobile device, as generated by the IPS, may be very accurate, while at other times less accurate or even inaccurate. In addition, the amount of traffic in the store, referred to as the amount of generated scan-location data, also varies between stores. Some stores may have a high number of daily users while others may have a smaller number of daily users.

As will become apparent from the description below, the disclosed embodiments provide methods and systems that produce up-to-date realograms, generated from in-store location data (positioning data) and product scan data, that account for all of the above-mentioned factors and considerations.

Embodiments of the present disclosure are directed to a method that comprises: receiving, for each mobile device of one or more mobile device, scan-location data that includes product scan data and associated location data for the mobile device, the product scan data being generated in response to scanning of a product by the mobile device and the location data being indicative of a location of the mobile device at a time of the scanning of the product; and processing the scan-location data of the one or more mobile device to produce a realogram of products scanned by the one or more mobile device.

Optionally, the processing the scan-location data includes: filtering the scan-location data of the one or more mobile device to produce filtered scan-location data sets, and for each product in the filtered scan-location data sets, performing a clustering algorithm to produce a product cluster data set that includes a cluster of product placement locations descriptive of potential product locations associated with the product, and the realogram of the products scanned by the one or more mobile device is produced based at least in part on the product cluster data sets.

Optionally, filtering the scan-location data includes filtering out data based on one or more of: time of the scanning of the product, accuracy of the location data, a vicinity of the location indicated by the location data to a store containing the product, consistency of accuracy of product scans by mobile devices, or presence of batch product scans.

Optionally, the clustering algorithm produces a number of clusters that is unknown prior to execution of the clustering algorithm.

Optionally, the clustering algorithm is an algorithm based on one or more of the following algorithms: ordering points to identify clustering structure (OPTICS) algorithm, density-based spatial clustering of applications with noise (DBSCAN) algorithm, affinity propagation, and mean-shift.

Optionally, the clustering algorithm produces the product cluster data based on time data and location data.

Optionally, the processing the scan-location data further includes: post-processing the product cluster data sets to produce post-processed product cluster data sets, and estimating, for each product in the post-processed product cluster data sets, a placement location confidence indicative of a confidence of locating the product in each potential product location, and the realogram of the products scanned by the one or more mobile device is produced based at least in part on the post-processed product cluster data sets and the estimated placement location confidence.

Optionally, the estimated placement location confidence includes an estimated recency confidence indicative of a confidence, for each potential product location, that the product is still located at the potential product location.

Optionally, the estimated placement location confidence for each product is a function of the post-processed product cluster data sets.

Optionally, the product in each product cluster data belongs to one or more category, and the method further comprises: receiving input data derived from the product cluster data sets; filtering the input data to produce filtered data; for each category in the filtered data, performing a clustering algorithm to produce a category cluster data set that includes a cluster of product placement locations descriptive of potential product locations of different products belonging to a common category; post-processing the category cluster data sets to produce post-processed category cluster data sets; and estimating, for each category in the post-processed category cluster data sets, a second placement location confidence indicative of a confidence of locating a product that belongs to the category in each potential product location, and the realogram of the products scanned by the one or more mobile device is produced further based in part on the post-processed category cluster data sets and the estimated second placement location confidence.

Optionally, the input data derived from the product cluster data sets is the product cluster data.

Optionally, the input data derived from the product cluster data sets includes the post-processed product cluster data sets and the estimated placement location confidence.

Optionally, the method is optimized based on ground truth data.

Optionally, the ground truth data is based on actual in-store placement of products.

Optionally, the ground truth data is based on high-confidence estimates of placement locations of products in the produced realogram.

Optionally, the location data is provided by an indoor positioning system.

Embodiments of the present disclosure are directed to a system that comprises: a non-transitory computer readable storage media that stores program code; and a processor in communication with the non-transitory computer readable storage medium, the processor configured to execute the program code to: receive, for each mobile device of one or more mobile device, scan-location data that includes product scan data and associated location data for the mobile device, the product scan data being generated in response to scanning of a product by the mobile device and the location data being indicative of a location of the mobile device at a time of the scanning of the product, and process the scan-location data of the one or more mobile device to produce a realogram of products scanned by the one or more mobile device.

Optionally, the processor is configured to execute the program code to process the scan-location data of the one or more mobile device to produce a realogram for each product by: filtering the scan-location data of the one or more mobile device to produce filtered scan-location data sets, and for each product in the filtered scan-location data sets, performing a clustering algorithm to produce a product cluster data set that includes a cluster of product placement locations descriptive of potential product locations associated with the product, and the realogram of the products scanned by the one or more mobile device is produced based at least in part on the product cluster data sets.

Optionally, the processor is further configured to execute the program code to process the scan-location data of the one or more mobile device to produce a realogram for each product by: post-processing the product cluster data sets to produce post-processed product cluster data sets, and estimating, for each product in the post-processed product cluster data sets, a placement location confidence indicative of a confidence of locating the product in each potential product location, and the realogram of the products scanned by the one or more mobile device is produced based at least in part on the post-processed product cluster data sets and the estimated placement location confidence.

Optionally, the product in each product cluster data belongs to one or more category, and the processor being further configured to execute the program code to: receive input data derived from the product cluster data sets, filter the input data to produce filtered data, for each category in the filtered data, perform a clustering algorithm to produce a category cluster data set that includes a cluster of product placement locations descriptive of potential product locations of different products belonging to a common category, post-process the category cluster data sets to produce post-processed category cluster data sets, and estimate, for each category in the post-processed category cluster data sets, a second placement location confidence indicative of a confidence of locating a product that belongs to the category in each potential product location, mobile device is produced further based in part on the post-processed category cluster data sets and the estimated second placement location confidence.

Optionally, the input data derived from the product cluster data sets is the product cluster data.

Optionally, the input data derived from the product cluster data sets includes the post-processed product cluster data sets and the estimated placement location confidence.

Optionally, the system further comprises: an indoor positioning system (IPS) in communication with each mobile of device of the one or more mobile device, the IPS configured to determine, for each mobile device, a location of the mobile device based at least in part on sensor data received from one or more sensor of the mobile device.

In the present disclosure, the term “store”, as used in the context of a store that contains products for scanning by mobile devices, refers to any facility in which products can be purchased and/or picked-up, including facilities such as brick-and-mortar stores, fulfillment centers in which products that are already purchased or ordered can be picked up by purchasers (i.e., shoppers) or by store associates for delivery, and combinations thereof. A brick-and-mortar store can be a retail location of a retail chain of stores which can include franchise locations, or can be a stand-alone (i.e., non-chain) store. A fulfillment center (also referred to as an order pick-up location) can be part of a retail chain, for example a pick-up location part of a retail chain.

Unless otherwise defined herein, all technical and/or scientific terms used herein have the same meaning as commonly understood by one of ordinary skill in the art to which the disclosure pertains. Although methods and materials similar or equivalent to those described herein may be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present disclosure are herein described, by way of example only, with reference to the accompanying drawings. With specific reference to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

Attention is now directed to the drawings, where like reference numerals or characters indicate corresponding or like components. In the drawings:

FIG. 1 is a diagram of the architecture of an exemplary system embodying the present disclosure for generating realograms from product scan data and location data;

FIG. 2 is a diagram of the architecture of an exemplary mobile device that can operate with the system of FIG. 1;

FIG. 3 is a flow diagram illustrating a process for generating realograms from product scan data and location data, according to an embodiment of the present disclosure;

FIG. 4 is a flow diagram illustrating a process for product cluster processing that can be used for executing one of the steps of the process illustrated in FIG. 3, according to an embodiment of the present disclosure;

FIG. 5 is a flow diagram illustrating a process for categories cluster processing that can be performed in addition to the process illustrated in FIG. 4, according to an embodiment of the present disclosure;

FIG. 6 a schematic representation of the layout of a store with various product placements, product scan locations, product placements with common categories, and specific category regions; and

FIG. 7 is a flow diagram illustrating a process for generating realograms from product scan data and location data, according to an embodiment of the present disclosure.

### DESCRIPTION OF THE PREFERRED EMBODIMENTS

The present disclosed subject matter, also referred to herein as the disclosure, includes methods and systems that generate realograms from product scan data and location data.

Before explaining at least one embodiment of the disclosure in detail, it is to be understood that the disclosure is not necessarily limited in its application to the details of construction and the arrangement of the components and/or methods set forth in the following description and/or illustrated in the drawings and/or the examples. The disclosure is capable of other embodiments or of being practiced or carried out in various ways.

By way of introduction, each product in a store is typically identified by some unique identifier (ID), for example a Universal Product Code (UPC), that can be uniquely identified digitally in the store catalog. Each product also typically has metadata associated with it, such as the product name, product description, product ingredients, and one or more category to which the product belongs. For example, Garlic Powder can belong to Spices and Seasonings categories. Identifying category locations can also be useful, specifically to deal with unpopular products or low traffic in stores. By using more popular products to identify or learn the category or categories to which such popular products belong, and to determine the general location of the less popular products which belong to the same category or categories as popular products, a user can more easily find unpopular products.

A product scan is generally referred to the operation that a user performs with the user's mobile device, for example using an application executed on the mobile device, to uniquely identify a product in the user's vicinity. A product scan can be executed, for example, via a barcode scan using a camera of the mobile device (e.g., smartphone camera), a QR code scan (also, for example, using a camera of the mobile device), an RFID scan with an RFID scanner implemented as part of the mobile device or electronically coupled to the mobile device, or even an image capture using a camera of the mobile device followed by an image recognition process. In the context of the present disclosure, manually inserting a product barcode or other product identifier carrying code in some textual mobile user interface (UI) or marking a checkbox near a product id/name/image in the UI is considered a product scan. As will be discussed, in certain embodiments a user product-not-there check may also be included as part of, or in association with product scanning, on the user mobile device in order to provide feedback to the realogram generation process to allow faster updates of realograms.

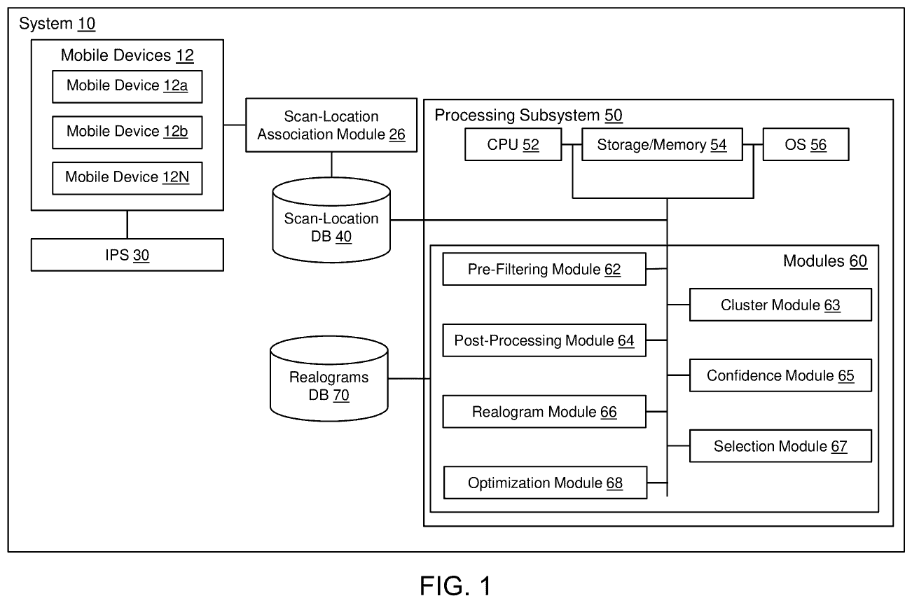

Bearing the above in mind, and referring now to the drawings, FIG. 1 illustrates a block diagram of a system, generally designated 10, according to certain non-limiting embodiments of the present disclosure. Generally speaking, the system 10 includes a scan-location association module 26, an indoor positioning system (IPS) 30, a scan-location database (DB) 40, and a processing subsystem 50. At least one mobile device 12 is also associated with, or can be part of, the system 10.

In the illustrated embodiment, three mobile devices, designated 12a, 12b, and 12N, are shown, however it should be understood that the present disclosure can operate with any number of mobile devices, and performance of the methods disclosed herein may increase with the number of mobile devices. Each of the mobile devices 12 can be implemented as any type of communication device that can be moved from one location to another, often while exchanging data via a communication network, such as a cellular network or a wireless local area network. Examples of such communication devices include, but are not limited to, smartphones, tablet computers, and laptop computers. Most typically, the mobile device 10 is implemented as a smartphone (such as an iPhone from Apple of Cupertino, CA) or a tablet computer (such as an iPad also from Apple of Cupertino, CA).

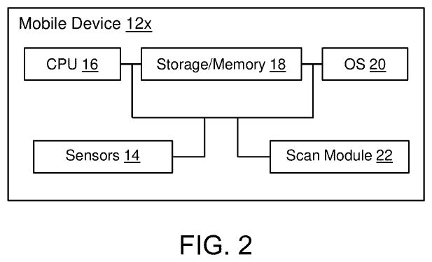

With continued reference to FIG. 1, refer also to FIG. 2, which illustrates a block diagram of an exemplary one of the mobile devices 12, designated in FIG. 2 as 12X. The mobile device 12X includes one or more sensor 14, a central processing unit (CPU) 16, a storage/memory 18, an operating system (OS) 20, and a scan module 22. The one or more sensor 14 may include a plurality of sensors, including, but not limited to, one or more inertial sensors such as one or more accelerometers and/or one or more gyroscopes, one or more magnetic sensors (magnetometers), one or more barometers, one or more radio sensors, one or more image sensors (that are part of a camera (i.e., imaging device), which can be a depth camera, of the mobile device 12X), one or more proximity sensors, or any other type of sensor that can provide sensor data that can be used by the embodiments of the present disclosure.

The one or more sensor 14 generates sensor data in response to various sensor measurements collected and performed at the mobile device 12X. The sensor data is provided to the IPS 30, which utilizes the sensor data generate location data indicative of an indoor location of the mobile device 12X, as will be discussed further below.

The CPU 16 is formed of one or more computerized processors, including microprocessors, for performing the functions of the mobile device 12X, including executing the functionalities and operations of the scan module 22, as well as executing the functionalities and operations of the OS 20. The processors are, for example, conventional processors, such as those used in servers, computers, and other computerized devices. For example, the processors may include x86 Processors from AMD and Intel, Xeon® and Pentium® processors from Intel, as well as any combinations thereof. Although the CPU 16 is shown as a single component for representative purposes, the CPU may be multiple components.

The storage/memory 18 is any conventional or application specific computer storage media. The storage/memory 18 stores machine executable instructions for execution by the CPU 16, to perform functions of the mobile device 12X. The storage/memory 18 also includes machine executable instructions associated with the operation of the components of the mobile device 12X, including the one or more sensor 14 and the scan module 22. Although the storage/memory 18 is shown as a single component for representative purposes, the storage/memory may be multiple components.

The OS 20 includes any of the conventional computer operating systems, such as those available from Microsoft of Redmond Washington, commercially available as Windows® OS, such as Windows® 10, Windows® 7, Apple of Cupertino, CA, commercially available as MAC OS, or iOS, open-source software based operating systems, such as Android, and the like.

The scan module 22 can be implemented in hardware, software, firmware, or a combination thereof, and is generally operative to perform product scans to generate product scan data. The scan module 22 can include a scanning application in the form of software that is executable on the mobile device 12X. The scan module 22 can also include hardware components with which the software application can interact. Such hardware components can include, but are not limited to, cameras for scanning barcodes or QR codes or performing image capture for an image recognition process (executed, for example, by the CPU 16), RFID scanners for scanning product RFID tags, and the like. The scan module 22 may also include a UI that allows the user of the mobile device 12X to manually enter product information, such as barcodes and the like, as discussed above. In certain embodiments, the UI may include a product-not-there check, as will be discussed in further detail below.

The IPS 30 functions to track the location of mobile devices 12 in a store that carries scannable products as the mobile devices 12 travel throughout the store. The IPS 30 tracks the location by, for example, processing sensor data received from the mobile devices 12 to generate location data indicative of an indoor location of each of the mobile devices 12 as the mobile devices 12 scan products in the store. The indoor location is generally inside of, or in the vicinity of, the store at which the products are located and scanned by the mobile devices. The IPS 30 generates the location data based at least in part on the sensor data collected by the mobile device. Although a single IPS 30 is shown in the drawings, each mobile device may be associated with its own IPS. Moreover, the IPS may reside in the mobile device itself, on a server that is remote from the mobile device (e.g., a cloud server), or partly in the mobile device and partly on the remote server.

The location data from the IPS 30 typically consists of at least horizontal coordinates, i.e., (x, y) in a cartesian coordinate system or latitude and longitude in the global earth coordinate system, or coordinates in another suitable coordinate reference frame, and may be associated with a floor plan visualization. The coordinate system may be associated with a building or a single floor in that building. In certain embodiments, the location data also includes height (altitude/elevation) data or the floor level or index, i.e. (x, y, z), (x, y, floorId), or (latitude, longitude, elevation). Without loss of generality, the remainder of the description will be provided in the context of location data on a single 2D floor, or simply a store map. However, extrapolation to three dimensions should be apparent to those of ordinary skill in the art.

The IPS 30 may provide additional data, including, for example, horizontal position/location accuracy, vertical position/location accuracy, elevation accuracy, as well as information on velocity, orientation of the mobile device, distance traveled from the beginning of the IPS session, and the like.

Modern IPS can provide 1-meter accurate mobile positioning indoors (and thus in-store), and further details of IPS and the location data that can be generated and provided by IPS is provided in commonly owned U.S. Pat. No. 10,584,972, the disclosure of which is incorporated by reference in its entirety herein.

The IPS 30 preferably provides location data for mobile devices with high enough frequency such that each time a mobile device performs a product scan, there is location data (generated by the IPS 30) at or near the time instance at which the product scan was performed. The location data also typically includes timestamps that indicate the time at which the mobile device was at each location described by the location data.

The scan-location association module 26 functions to associate product scan data (generated by a mobile device) with IPS location data (generated by the IPS 30), for example according to the time at which the product scan was performed. By associating the product scan data and the location data, the scan-location association module 26 produces scan-location data, which includes the product scan data (which can include multiple product scans) and location data of the mobile device associated with each product scan.

Typically, product scan data can include various data items or data segments, including the product unique ID, and the associated metadata (name, description, ingredients, etc., as discussed above). The product scan data also typically includes a timestamp that indicates the time at which the product scan was performed. The timestamp can be used by the scan-location association module 26 to associate product scan data with location data having the same (or approximately the same) timestamp.

The scan-location association module 26 can also add additional data to the scan-location association data, including, but not limited to, time data indicating a timestamp of each product scan of the scan data in the scan-location data, user ID that identifies a user of the mobile device that performed a product scan, an IPS session ID that identifies the session of the IPS during which the location data of the scan-location data was generated, an application session ID (also referred to as a user session ID) that identifies the session of the application (e.g., part of the scan module 22) or user during which a product was scanned, device type indicating the type of mobile device (for example smartphone and type, e.g., iPhone, Samsung, etc., tablet and type, e.g., iPad, etc.) that performed a product scan in the scan data, user type indicating the type of user (e.g., shopper, picker, store associate, etc.) that executed the product scan with his/her mobile device, etc.

Although the drawings show a single scan-location association module 26 that is shared among the mobile device 12, in certain embodiments each mobile device may have its own scan-location association module 26 that produces scan-location data for that mobile device.

In general, the stage (or process) during which data (product scan data, location data, and scan-location data) is collected by the system 10 is referred to as a data collection stage/process. The data collection stage includes generation of the product scan data (in response to product scanning by the mobile devices 12), generation of the location data (by the IPS 30), and generation of the scan-location data sets (by the scan-location association module 26). The data that is collected by the system 10 during the data collection stage is used by the system 10 (in particular the processing subsystem 50) for realogram processing to generate product realograms (having realogram data), as will now be discussed.

The processing subsystem 50 functions to receive the scan-location data for each of the mobile devices 12 associated with the system 10 collected during the data collection stage, and process scan-location data sets (comprised of the received scan-location data for the mobile devices 12) to produce a realogram (or realograms) for the products in the scan-location data sets. The stage/process during which the processing subsystem 50 processes the scan-location data sets to produce the realogram(s) is referred to as a realogram generation stage/process, and can also be referred to as a product placement learning phase.

In certain embodiments, the realogram generation stage/process is separated in time from the data collection stage, preferably by enough time to allow for the scan-location data sets to build-up with sufficient product scan data and location data. In such embodiments, the processing subsystem 50 processes the scan-location data sets a certain amount of time after the scan-location data sets are generated. For example, the processing subsystem 50 may execute the realogram generation stage/process once per day, once per week, or at any other suitable processing interval. The delay between data collection and realogram processing may be fixed or variable.

In certain embodiments, the scan-location association module 26 can provide the scan-location data produced for each mobile device directly to the processing subsystem 50 for processing. In such embodiments, the processing subsystem 50 may store the scan-location data sets in a data buffer or memory associated with the processing subsystem 50 (for example storage/memory 54) to allow the scan-location data sets enough time to build-up before processing by the processing subsystem 50.

In other embodiments, such as the embodiment illustrated in FIG. 1, the scan-location data for each mobile device (i.e., the product scan data and the associated location data for each mobile device) is stored in a repository, such as the scan-location DB 40, which can compile the scan-location data from the mobile devices 12 associated with the system 10 over time to form scan-location data sets. In such embodiments, the processing subsystem 50 periodically retrieves the scan-location data sets from the scan-location DB 40 for realogram generation processing. The retrieval periods may be at fixed intervals (for example once per day, once per week, etc.) or at variable intervals (for example at a first time-instance, and then at a second time-instance that is two days after the first time-instance, and then at a third time-instance that is one day after the second time-instance, and then a fourth time-instance that is one week after the third time-instance, etc.).

The following paragraphs describe the components of the processing subsystem 50 according to certain non-limiting embodiments of the present disclosure, and the functions performed by the aforementioned components.

The processing subsystem 50 provides logic and logic functions, and is generally configured to receive scan-location data (for example from the scan-location DB 40), and process the received scan-location data sets to produce a realogram(s) of the products in the scan-location data sets. The processing subsystem 50 includes a CPU 52, a storage/memory 54, an OS 56, and a collection of computerized modules 60. Although the CPU 52 and the storage/memory 54 are each shown as single components for representative purposes, either or both of the CPU and the storage/memory may be multiple components. In the non-limiting exemplary embodiments illustrated in FIG. 1, the computer modules 60 include a pre-filtering module 62, a cluster module 63, a post-processing module 64, a confidence module 65, and a realogram module 66. In certain embodiments, a selection module 67, and an optimization module 68 are also included.

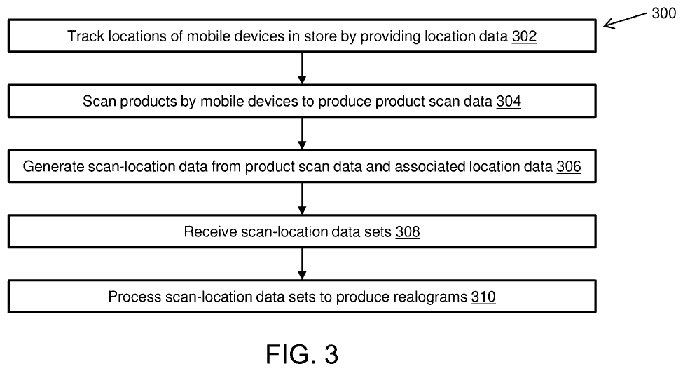

The CPU 52 is formed of one or more computerized processors, including hardware processors, executing the functionalities and operations of the module 60 and performing the processes (methods) of the present disclosure, such as the processes (methods), and/or sub-processes thereof, shown in the flow diagrams of FIGS. 3-5 and 7, and detailed below. These processes and sub-processes of FIGS. FIGS. 3-5 and 7 may be in the form of programs, algorithms and the like. The processors of the CPU 52 can, for example, be conventional processors, such as those used in servers, computers, and other computerized devices. For example, the processors may include x86 Processors from AMD and Intel, Xeon® and Pentium® processors from Intel, as well as any combinations thereof. In other embodiments, the processors can be special-purpose or application-specific processors.

The CPU 52 is electronically coupled (connected) to the storage/memory 54, which can be any conventional computer storage media and which stores machine executable instructions for execution by the CPU 52, for performing processes of the present disclosure, such as the processes, and/or sub-processes thereof, shown in the flow diagrams of FIGS. 3-5 and 7, as will be detailed in subsequent sections of this document.

The CPU 52 is also electronically coupled (connected), either directly or indirectly, to the various modules 60 (which are computer components) that are configured to perform the various logic functions of the present disclosure. The CPU 52 is further electronically coupled (connected) to an operating system (OS) 56 that may load machine executable instructions, stored in the storage/memory 54, for execution by the CPU 52. The OS 16 may include any of the conventional computer operating systems, such as those available from Microsoft of Redmond Washington, commercially available as Windows® OS, such as Windows® 10, Windows® 7, MAC OS from Apple of Cupertino, CA, or Linux, or may include real-time operating systems, or may include any other type of operating system typically deployed in computer systems as known in the art.

The aforementioned modules 60 (computer components) are configured to perform the various logic functions of the disclosed embodiments. Typically, the processing subsystem 50 includes software, software routines, computer program code, computer program code segments and the like, embodied, for example, in modules, computer components, and the like (exemplarily illustrated as computer modules 60). The computer modules 60, as computer components, are stored in a non-transitory computer readable storage medium, which is preferably one of the components of the storage/memory 54 or another non-transitory computer readable storage medium electronically coupled to the CPU 52, such that the machine executable instructions stored in the computer modules 60 can be loaded and executed by the CPU 52.

The CPU 52, for example, typically in conjunction with the storage/memory 54 and/or another non-transitory computer readable storage medium that stores the computer modules 60, runs the aforementioned programs or algorithms of FIGS. 3-5 and 7, as detailed below. The aforementioned programs or algorithms are, for example, represented in various forms including machine language/machine code for various types of processors, assembly for various types of processors, Java byte code, or in a programming language such as the “C” programming language, Java, JavaScript, Python, Go, C#, or other programming languages, as well as intermediate representations of the programming languages.

The following paragraphs describe the functions performed by the various computer modules 60 according to certain embodiments of the present disclosure.

The pre-filtering module 62 functions to filter received input data. According to certain embodiments, the pre-filtering module 62 is configured to receive scan-location data sets as input and perform a pre-filtering process on the scan location data sets to produce one or more sets of filtered scan-location data. The pre-filtering module 62 performs the pre-filtering process by selecting relevant scan-location data from the data set according to filtering rules (logic). The purpose of this filtering process is to remove (i.e., filter out) unreliable or less reliable data from the scan-location data sets.

According to certain embodiments, the pre-filtering module 62 implements simple (i.e., low complexity) filter rules, which can include use-case specific rules, which reduce processing time. For example, the pre-filtering module 62 can filter out data based on the time of the scanning of the product and/or the accuracy of the location data in the scan-location data. When filtering based on the time of the scanning of the product, the pre-filtering module 62 can filter product scan times such that only product scan data from within a specific time period (for example the past few weeks or month, e.g., the past 3 months) is retained in the filtered scan-location data. When filtering based on the accuracy of the location data, the pre-filtering module 62 may filter the location data such that data with location accuracy below a certain threshold is removed (i.e., location data with location accuracy above a threshold is retained in the filtered scan-location data). The pre-filtering module 62 may also filter the location data based on a vicinity of the location (indicated by the location data) to the store that contains the scanned product, or based on a vicinity of the location to a bounding polygon of the store (in situations in which the location data generated by the IPS 30 is corrupted or the users of the mobile devices 12 performed product scanning outside of the store). When performing such vicinity-based filtering, the pre-filtering module 62 can remove any location outside of the vicinity of the store or bounding polygon of the store location.

According to certain embodiments, the pre-filtering module 62 implements more sophisticated filtering rules instead of or in addition to the above-mentioned simple filter rules. For example, the pre-filtering module 62 may analyze the location data in the scan-location data to filter out any location data having inconsistent accuracy of the location of the mobile device(s) 12 traveling through the store. For example, for a particular application session (or user session), the pre-filtering module 62 can analyze the scan-location data to identify a number of consecutive accurate scan-locations which are apart from each other by at least a certain distance (for example three consecutive scan-locations that are at least five meters apart from each other) which indicates accurate scan-locations, and then only utilizing scan-location data from that point onward for that session. As an additional example, the pre-filtering module 62 filters out scan-location data with not enough associated product representation. For example, the pre-filtering module 62 may analyze the scan-location data to identify the number of scan-locations for each product (for example based on product ID) and then filter out scan-locations below a certain threshold to retain scan-locations above the threshold (for example retaining only scan-location data for product ID X if there are at least Y instances of scanning the product X).

The pre-filtering module 62 may also filter scan-location data to remove data associated with problematic behavior of the users of the mobile devices 12, for example batch scanning. In batch scanning, a user of a mobile device may collect several products in hand and travel with them to another location within the store before actually scanning any of the collected products, and only then scan all of the un-scanned collected products as a batch resulting in different products being scanned at the same location in the user session. This can create a displacement between the location of a product scan and the actual location of the product on the shelf in the store. To identify cases of batch scanning, the pre-filtering module 62 may analyze the scan-location data to identify, within the same user session, consecutive scans of different products with the same location data. Once such consecutive scans are identified, the pre-filtering module 62 may filter the scan-location data to remove data corresponding to the identified consecutive scans. The timestamps of the product scans can also be used to identify such consecutive scans, for example by looking for consecutive scans of different products with the same location data and with time stamps that are a few (e.g., less than ten seconds) seconds apart between a pair of consecutive scans.

The cluster module 63 functions to execute (perform) one or more clustering algorithm on received input data. According to certain embodiments of the present disclosure, the cluster module 63 is configured to receive as input from the pre-filtering module 62 the filtered scan-location data (i.e., the relevant scan-location data that is retained after pre-filtering by the pre-filtering module 62). The cluster module 63 processes the filtered scan-location data by performing, for each product in the filtered scan-location data, a clustering algorithm, or algorithms, to produce a product cluster data set that includes a cluster of product placement locations descriptive of potential product locations associated with the product. In other words, the cluster module 63 identifies, for each product in the filtered scan-location data, the possible multi-placements of the product in the store (or on a store map). It is noted that the cluster module 63 may operate on the un-filtered scan-location data. However, due to the potential presence of irrelevant data in the un-filtered scan-location data, executing the clustering algorithm(s) on the un-filtered data may produce less accurate clusters, resulting in inaccurate realograms.

The clustering algorithm(s) executed by the cluster module 63 group the (filtered) scan-location data of a single product ID together into one or more groups, preferably according to the scan-location vicinity and concentricity, in space and time. In certain non-limiting implementations, the clustering algorithm executed by the cluster module 63 is implemented as, or is based on, one or more of ordering points to identify clustering structure (OPTICS) algorithm, density-based spatial clustering of applications with noise (DBSCAN) algorithm, affinity propagation, and mean-shift. These clustering algorithms are well-known in the art of machine learning.

The clustering algorithm(s) executed by the cluster module 63 is/are chosen so that the cluster module 63 can identify the number of clusters per product. In cases where a product described in the (filtered) scan-location data has a single placement location in the store, it is expected that the product will have a single cluster. However, it is also expected that at least some of the products described in the (filtered) scan-location data will be in multiple placement locations (i.e., more than one placement in-store), and therefore any product having multiple placement locations is expected to have multiple clusters. Thus, the actual number of clusters (corresponding to location placements in the store) for any given product is unknown prior to the execution of the clustering algorithm(s) by the cluster module 63. Due to this potential for multiple placement locations for a single product, and therefore multiple clusters for a single product, k-means clustering is a less suitable algorithm for embodiments of the present disclosure.

In certain embodiments, the cluster module 63 preferably tunes parameters of the clustering algorithm(s) in order to achieve optimal or near-optimal realograms. For example, if using an algorithm based on DBSCAN, the neighborhood radius can dictate the accuracy of the produced realograms. Techniques for optimization of the realograms will be discussed in subsequent sections of the present disclosure.

According to certain embodiments, the cluster module 63 may implement the clustering algorithm by making modifications or adjustments to a known clustering algorithm, for example in order to handle outliers remaining in the product cluster data. For example, one or more of the above-mentioned clustering algorithms can be modified to utilize the median and not the mean as the product placement location, and/or modified to include a time dimension to the product cluster data output so as to also consider changes of products placements in the store over time.

The post-processing module 64 functions to receive data as input and to post-process the received data. According to certain embodiments, the post-processing module 64 is configured to receive the product cluster data sets as input from the cluster module 63, and to perform post-processing on the product cluster data sets to produce post-processed product cluster data. In certain embodiments, the post-processing performed by the post-processing module 64 includes data filtering and/or statistics extraction (i.e., statistical analysis). The post-processing module 64 can perform data filtering to filter the product cluster data sets for example by removing remaining outliers in the product cluster data sets. For example, the post-processing module 64 may remove outliers by processing the product cluster data sets to remove clusters with average scans location accuracy above a certain threshold or with too few data points. As an additional example, the post-processing module 64 may filter the product cluster data sets to adjust cluster locations by giving more weight to scan-locations with more recent timestamps, thus adapting faster to product location changes in the store. The post-processing module 64 can perform statistical analysis to extract cluster statistics from the product cluster data sets, for example, by processing the product cluster data sets to compute cluster statistics, for example, cluster location accuracy and/or cluster scan rate (the number of scans per day for a given cluster).

Upon completion of the processing of the product cluster data sets by the post-processing module 64, each resulting cluster corresponds to a single product placement in the store.

The confidence module 65 functions to process received input data and compute confidence estimates for that data. According to certain embodiments, the confidence module 65 is configured to receive the post-processed product cluster data sets as input from the post-processing module 64, and to compute, for each product in the post-processed product cluster data sets, an estimate of a placement location confidence (referred to as “placement confidence”) indicative of a confidence of locating the product in each potential product location. In other words, the confidence module 65 computes a confidence for each product placement.

In certain embodiments, the estimate is a probability metric describing the chances (i.e., probability) of finding the product in that location. In other embodiments, instead of using the confidence as a probability, a different metric, such as the location accuracy or some other defined metric, can be used. Although it may be intuitive to define the estimated confidence as a probability, without loss of generality the estimated confidence is more generally any function that is defined over the (post-processed) product cluster data sets.

According to certain embodiments, the estimated placement confidence includes an estimated placement location confidence and an estimated placement recency confidence. The estimated placement location confidence describes how confident the processing subsystem 50 is regarding the placement location of a product, and the estimated placement recency confidence describes how confident the processing subsystem 50 is that the product is still at the location (keeping in mind that a given product may be out-of-stock or completely removed from the catalog). In particular, the placement location confidence is a function of the number of scan-locations in the corresponding cluster, and the placement recency confidence is a function of the cluster scanning rate statistics.

The realogram module 66 functions to receive data as input and to produce one or more realogram from the received data. The realogram(s) produced from the received input data include realogram data that is descriptive of the actual location (based on location data, i.e., coordinates) of the products (associated with the realogram) at a given time. According to certain embodiments, the realogram module 66 receives product cluster data sets (for example a product cluster data set for each product) as input from the cluster module 63, and produces a realogram of the products in the cluster data sets based on the received product cluster data sets. It is noted, however, that because the product cluster data, prior to post-processing by the post-processing, may include outliers, in certain preferred embodiments the realogram module 66 receives the post-processed product cluster data sets as input from the post-processing module 64, and produces a realogram of the products in the post-processed product cluster data sets based on the received post-processed product cluster data sets.

The produced realogram may be a newly generated realogram, for example for a store that did not previously have an associated realogram, or may be an updated realogram, for example for a store that already had an existing associated realogram. For example, for a given store having an existing realogram of products, the realogram of products may be updated as products in that store are newly scanned and the new scans are collected as part of new scan-location data. According to certain embodiments, the realogram module 66 produces the realogram of products (i.e., a realogram of placement of the products) by generating or updating, for each store map, a list of uniquely identified products with their uniquely identified placements (locations) based on the product cluster data sets.

In certain more preferred embodiments, the realogram module 66 also takes into consideration the estimated placement location confidence to produce the realograms. In such more preferred embodiments, the realogram module 66 receives the post-processed product cluster data sets as input from the post-processing module 65 and receives the estimated placement location confidence as input from the confidence module 65, and produces a realogram of products based at least in part on the received post-processed product cluster data sets and the estimated placement location confidence. The realogram module 66 produces the realogram of products by generating or updating, for each store map, a list of uniquely identified products with their uniquely identified placements based on the post-processed product cluster data sets and the estimated placement location confidence. Each placement may have associated therewith additional data, such as the placement confidence (placement location confidence and placement recency confidence), scanning rate statistics, latest scanning day, etc. Further indicators may also be applied to (associated with) the product placement data. For example, if the recency for a product dropped below a certain threshold, or the latest scanning of the product was too far in the past with respect to the average scanning rate, this could indicate that the product was removed from store catalog altogether.

Attention is now directed to FIG. 3, which shows a flow diagram detailing a computer-implemented process 300 in accordance with embodiments of the disclosed subject matter. The computer-implemented process includes an algorithm for producing up-to-date realograms for various products of a store. Reference is also made to the elements of FIGS. 1 and 2. The process and sub-processes of FIG. 3 include computerized (i.e., computer-implemented) processes performed by the system 10, including, for example, the mobile devices 12, the IPS 30, the scan-location association module 26, and the processing subsystem 50 including the CPU 52 and associated components, including the pre-filtering module 62, the cluster module 63, the post-processing module 64, the confidence module 65, and the realogram module 66. The aforementioned process and sub-processes are for example, performed automatically, but can be, for example performed manually, and are performed, for example, in real time.

The process 300 begins at step 302, where the IPS 30 initiates an IPS service to track the location of mobile devices 12 in the store carrying the scannable products as the mobile devices 12 travel throughout the store. As discussed above, the IPS 30 tracks the location of each mobile device by providing location data indicative of an indoor location of each of the mobile devices 12 as the mobile devices 12 scan products in the store.

At step 304, one or more of the mobile devices 12 scan products in the store to generate for each scanned product corresponding product scan data.

At step 306, the scan-location association module 26 generates scan-location data, for each mobile device, that includes product scan data (generated by the mobile device) and associated location data (generated by the IPS 30) according to the time at which the product scan was performed. In certain embodiments, the scan-location data for each mobile device is stored in the scan-location DB 40 for later retrieval by the processing subsystem 50.

At step 308, the processing subsystem 50 retrieves/receives, for each of the mobile devices 12, the scan-location data for that mobile device. In other words, the processing subsystem 50 retrieves/receives multiple sets of scan-location data (i.e., scan-location data for multiple mobile devices). Each set of scan-location data includes product scan data and associated location data for a particular mobile device.

At step 310, the processing subsystem 50 processes the scan-location data sets of the mobile devices 12 to produce a realogram consisting of at least some of the products in the scan-location data sets. The realogram consists of at least some of the products because some of the products in the scan-location data sets may be filtered out during pre-filtering or post-processing. The scan-location data sets of the mobile devices 12 are processed together to generate the realograms, for example by first aggregating or combining together the scan-location data set of each of the mobile devices 12 into a single data set, and then processing that data set (or co-processing the scan-location data sets) to produce at least one the realogram of the scanned products.

At the conclusion of step 310, the realogram(s) can be stored, preferably in a structured format, in a memory or database that is part of or otherwise associated with the system 10, for example realograms database (DB) 70 that communicates with the processing subsystem 50 (for example through an electronic connection or through a wired or wireless network connection).

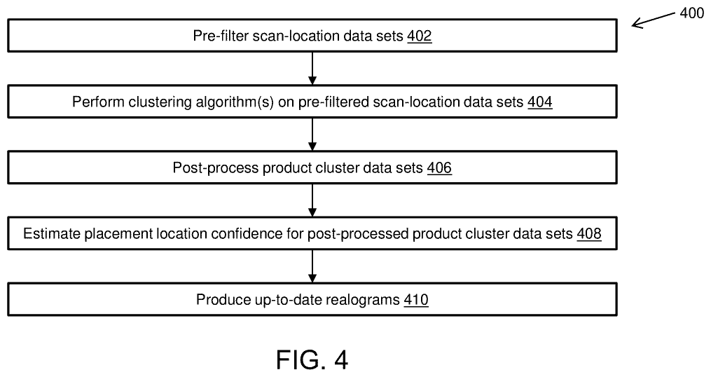

With continued reference to FIGS. 1-3, refer now to FIG. 4, which shows a flow diagram detailing a computer-implemented process 400 in accordance with embodiments of the disclosed subject matter. The computer-implemented process 400 includes an algorithm for, among other things, performing parts of step 310 of the process 300 of FIG. 3. In particular, the process 400 includes an algorithm for processing scan-location data to produce realograms. The process and sub-processes of FIG. 4 are computerized (i.e., computer-implemented) processes performed by the system 10, including, for example, the processing subsystem 50 including the CPU 52 and associated components, including the pre-filtering module 62, the cluster module 63, the post-processing module 64, the confidence module 65, and the realogram module 66. The aforementioned process and sub-processes are for example, performed automatically, but can be, for example performed manually, and are performed, for example, in real time.

The process 400 begins at step 402 where the data set comprised of the scan-location data of the mobile devices 12 is pre-filtered, for example by the pre-filter module 62, to produce filtered scan-location data sets. As discussed above, the pre-filtering module 62 may filter the data set based on, for example, the time of the scanning of the product, and/or the accuracy of the location data in the scan-location data, and/or consistency of accuracy of the location of the mobile device(s) 12 traveling through the store, and/or amount of product representation associated with the scan-location data, and/or problematic behavior of the users of the mobile devices 12 (e.g., batch scanning).

At step 404, clustering algorithm(s) is/are performed, for example by the cluster module 64, on the filtered scan-location data sets to produce product cluster data sets that include, for each product, a cluster of product placement locations descriptive of potential product locations associated with the product.

At step 406, the data set comprised of the cluster data set for each product is optionally post-processed, for example by the post-processing module 64, to produce post-processed product cluster data sets. As discussed above, the post-processing can be performed to filter the product cluster data sets (for example by removing remaining outliers in the product cluster data sets) and/or to extract cluster statistics from the product cluster data sets. Upon completion of the post-processing of the product cluster data, each resulting cluster corresponds to a single product placement in the store.

At step 408, the post-processed product cluster data is optionally further processed, for example by the confidence module 65, to compute, for each product in the post-processed product cluster data, an estimate of a placement location confidence (“placement confidence”) indicative of a confidence of locating the product in each potential product location. As discussed above, the estimated placement confidence can include an estimated placement location confidence (describing confidence regarding the placement location of a product) and an estimated placement recency confidence (describing confidence that the product is still at the location).

At step 410, product cluster data is processed, for example by the realogram module 66, to produce the up-to-date realogram of products (i.e., a realogram of placement of the products). As discussed above, the realogram is produced by generating or updating, for each store map, a list of uniquely identified products with their uniquely identified placements, based on the product cluster data. In preferred embodiments, at step 410 the post-processed product cluster data sets are processed, for example by the realogram module 66, to produce the realogram of products, and in more preferred embodiments the post-processed product cluster data sets and the estimated placement location confidence are processed together, for example by the realogram module 66, to produce a more accurate up-to-date realogram of the products. As discussed above, in such more preferred embodiments the realograms are produced by generating or updating, for each store map, a list of uniquely identified products with their uniquely identified placements based on the post-processed product cluster data and the estimated placement location confidence.

As mentioned above, in certain embodiments the realogram generation stage/process is separated in time from the data collection stage, to allow enough time for the scan-location data sets to build-up with sufficient product scan data and location data. In other words, steps 302 through 306 of FIG. 3 are preferably performed a certain amount of time (e.g., one or more days, etc.) prior to the execution of step 310 (or equivalently steps 402 through 410 of FIG. 4). In addition, in certain embodiments the scan-location data sets used for realogram generation can be enriched with additional data to increase the accuracy of the final realogram(s). For example, if prior to executing step 310 there exists a planogram or some historic realogram that is somewhat accurate (e.g., accuracy above a certain threshold), the planogram or historic realogram can be retrieved and incorporated as part of the scan-location data sets or directly added to the resulting realogram of product placements where applicable. The planogram or historic realogram can be retrieved, for example, from a memory or database that is part of or otherwise associated with the system 10. For example, the planogram may be stored in a memory of a computer system operated by the store. As another example, the historic realogram may be stored in a database, such as the realogram DB 70.

According to certain embodiments, in addition to product clustering (as described with reference to FIG. 4), the processing subsystem 50 may also perform categories clustering. As discussed above, each scannable product typically belongs to one or more category. The goal of performing categories clustering is to group together product placements that have a common category between them. In the non-limiting embodiment of the processing subsystem 50 described herein, the categories clustering is performed jointly by the pre-filtering module 62, the cluster module 63, the post-processing module 64, and the confidence module 65. It is noted, however, that other embodiments are contemplated in which the processing subsystem 50 includes a separate set of dedicated modules that are specifically configured to perform pre-filtering, clustering, post-processing, and confidence estimation based on categories and not based on products.

The categories clustering processing is performed on input data, which in certain embodiments can be the product cluster data (i.e., the output of step 404 of FIG. 4), but in more preferred embodiments is the post-filtered product cluster data and the estimated placement location confidence (i.e., the output of steps 406 and 408 of FIG. 4).

In certain embodiments when categories clustering is performed, the pre-filtering module 62 further functions to receive input data (e.g., product cluster data or post-filtered product cluster data and the estimated placement location confidence) and to filter the input data to produce filtered data. The filtering can include, for example, filtering out placements with low confidence, or low placement location (in the product cluster data, or in the post-processed product cluster data based on the estimated placement location confidence).

In certain embodiments when categories clustering is performed, the cluster module 63 further functions to receive input data (e.g., the filtered data received from the pre-filtering module 62) and to execute (perform) one or more clustering algorithm on received input data. The categories clustering performed by the cluster module 63 is generally similar to the product clustering, except here there may be several regions (similar to placements) associated with each category, and the clustering algorithm(s) find an unknown number of category clusters. The cluster module 63 processes the input data (e.g., the filtered product cluster data, the filtered post-processed product cluster data, etc. received from the pre-filtering module 62) to produce categories cluster data sets where each category cluster is a cluster of product placement locations descriptive of potential product locations of different products belonging to a common category.

In certain embodiments when categories clustering is performed, the post-processing module 64 further functions to received input data (e.g., the categories cluster data sets from the cluster module 63) and to perform post-processing on the categories cluster data sets to produce post-processed categories cluster data sets. This post-processing can include filtering, for example calculating or determining a region boundary that encompasses a cluster of product placements, and filtering out any cluster within the boundary having few, or a small amount of, product placements, or placements below some confidence threshold. The remaining category clusters (after filtering) are referred to hereinafter as category regions.

In certain embodiments when categories clustering is performed, the confidence module 65 further functions to received input data (e.g., the category regions from the post-processing module 64) and to compute, for each product category, an estimate of a category location confidence indicative of a confidence of locating a product of that category in the category region.

In embodiments in which the processing subsystem 50 performs categories clustering, the realograms can be generated further based on the category regions to incorporate product category information into the realograms. In such embodiments, the realogram data includes categories data that is descriptive of the category information of the product (associated with the realogram) at a given time.

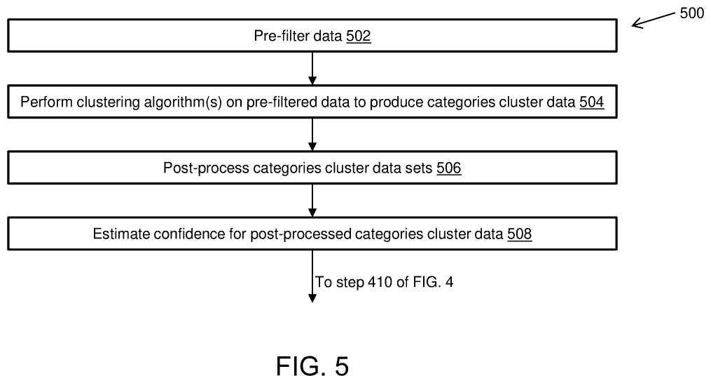

With continued reference to FIGS. 1-4, refer now to FIG. 5, which shows a flow diagram detailing a computer-implemented process 500 in accordance with embodiments of the disclosed subject matter. The computer-implemented process 500 includes an algorithm for, among other things, performing steps for categories clustering. The process and sub-processes of FIG. 5 are computerized (i.e., computer-implemented) processes performed by the system 10, including, for example, the processing subsystem 50 including the CPU 52 and associated components, including the pre-filtering module 62, the cluster module 63, the post-processing module 64, the confidence module 65, and the realogram module 66. The aforementioned process and sub-processes are for example, performed automatically, but can be, for example performed manually, and are performed, for example, in real time.

The process 500 begins at step 502 where the product cluster data (output of step 404 of FIG. 4) and more preferably the post-filtered product cluster data and the estimated placement location confidence (the output of steps 406 and 408 of FIG. 4) is pre-filtered, for example by the pre-filter module 62, to produce filtered data. As discussed above, the filtering can include, for example, filtering out placements with low confidence, or low placement location.

At step 504, clustering algorithm(s) is/are performed, for example by the cluster module 64, on the filtered data output at step 502 to produce categories cluster data sets where each category cluster is a cluster of product placement locations descriptive of potential product locations of different products belonging to a common category.

At step 506, the categories cluster data sets are optionally post-processed, for example by the post-processing module 64, to produce post-processed categories cluster data sets. As discussed above, the post-processing can include filtering, for example filtering out any cluster within a calculated region boundary having few, or a small amount of, product placements, or placements below some confidence threshold.

At step 508, the post-processed categories cluster data sets are optionally further processed, for example by the confidence module 65, to compute, for each product category, an estimate of a category location confidence indicative of a confidence of locating a product of that category in the category region.

The realogram generation step 410 of FIG. 4 can then be executed further based on outputs from the process 500, in particular the output of step 504, and more preferably the output of steps 506 and 508. In a particularly preferred embodiment, step 410 of FIG. 4 is executed based on the outputs from steps 406 and 408 of FIG. 4 and steps 506 and 508 of FIG. 5.

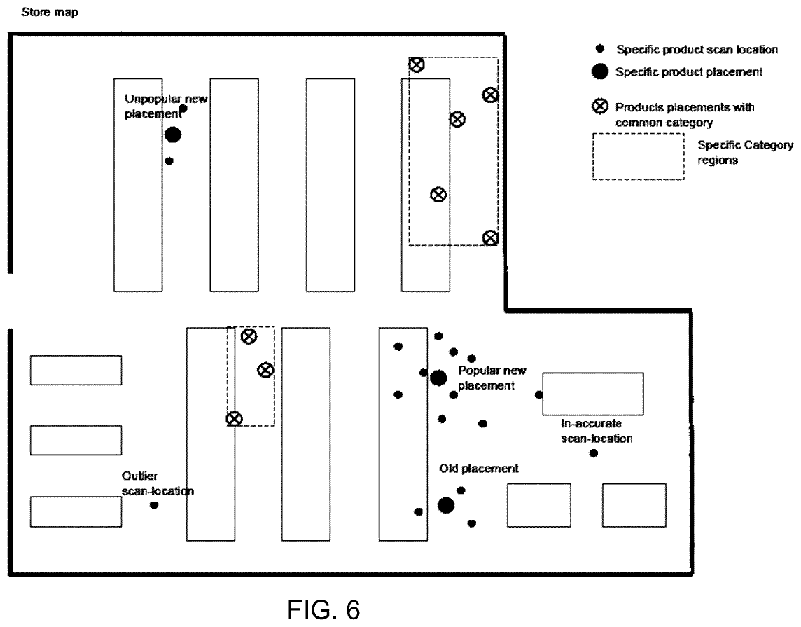

To provide a visual representation of the realogram generation process described above, and with continued reference to FIGS. 3-5, attention is now directed to FIG. 6 which shows a schematic representation of the layout of a store with various product placements, product scan locations, product placements with common categories, and specific category regions.

According to certain embodiments, the processing subsystem 50, for example using the selection module 67, can execute a selection process to reduce realogram usage by filtering data from realograms and/or combining aspects of some realograms. For example, the selection module 67 may process realogram data to exclude product placement and categories regions with confidence estimates that are too low (e.g., below threshold values).

In addition, the selection module 67 may combine different category regions into a single region per category, and may also exclude category regions having region boundaries that are too large (e.g., above a threshold area, for example larger than 100 square meters or larger than 5% of the size of the store) as large category regions may not provide meaningful location information. The processing performed by the selection module 67 can be executed as part of step 410.

As briefly mentioned above the realogram generation process, for example as described with reference to FIGS. 3-5, is preferably optimized for optimal realogram generation performance. The optimization is performed by the processing subsystem 50, for example the optimization module 68, and may be performed based on evaluation of certain key qualitative metrics of the generated realograms, including, but not limited to: 1) learning coverage, which can be defined as the number of product placements (or category regions) learned or identified from the collected scan-location data sets, 2) the accuracy of the product placements locations (or category regions boundaries), and 3) the accuracy of the placement confidence (or regions confidence).

Optimization targets may vary depending on the particular use case. For example, scan-location data for a shopping list application is inherently different from RFID employee storehouse scans. The behavior of the users in the two cases is different, the accuracy of the scan-location data is different, and the outliers in the scan-location data are different by nature and the target requirement may be different. Nevertheless, the optimization process as will be described below still applies, and only a certain number of parameters/functions in the process needs to be optimized. Those parameters/functions can include, for example, pre-filtering thresholds applied by the pre-filtering module 62), the neighborhood radius of the clustering algorithm, the confidence function, selection thresholds applied by the selection module 67, and the like.

In order to calculate some of the quality properties of the realogram for optimization, a Ground Truth (GT) data set, descriptive of the actual/true placement of products, should be collected and evaluated against the realogram placement and category regions. While in theory it is possible to collect GT data, for example with rigorous in-store processes of manually entering product placement locations, GT data may also be synthetic data derived from product placement locations that are estimated by the processing subsystem 50 for some initial optimizations of the realogram generation process. The synthetic GT data should be highly accurate data, and therefore it is preferable to choose placement location estimates having extremely high confidence, i.e., very popular placements, for example as calculated by the confidence module 65. By taking such placements, and removing scan-locations randomly from the cluster to which the placement location estimates belong, the processing subsystem 50 can also simulate un-popular placements or products as well. Similarly, the processing subsystem 50 can simulate changes over time by manipulating the scan-location time data for the cluster to which the placement location estimates belong.

The following paragraph provides a more detailed discussion of some of the realogram quality properties (also referred to as performance metrics) that can be used, for example, for realogram optimization. The realogram quality properties can include, but are not limited to, 1) products learning coverage, which can be defined as the number of unique products in the collected scan-location data sets, 2) categories learning coverage, which can be defined as the number of unique categories in the scan-location data sets, 3) placement location accuracy, which can be defined as the distance (e.g., Euclidean distance) between GT location and estimated placement location, 4) placement confidence, which can be defined as the likelihood or probability finding a product in the vicinity (e.g., within 3 meters) of the GT location on the day of the last collection of scan-location data having that product, 5) placement location confidence, which can be defined as the likelihood or probability of finding a product in the vicinity (e.g., within 3 meters) of the GT location on the day that the product was scanned, 6) placement recency confidence, which can be defined as the likelihood or probability that the product is still in the GT location on the day of the last collection of scan-location data having that product, 7) category region accuracy, which can be defined as a similarity measure between the region estimated boundary and GT boundary, and 8) category region confidence, which can be defined as the likelihood or probability of finding a product with the same category within the category region boundary.

In certain embodiments, one or more (and preferably all) of the above described realogram quality properties are compared to corresponding GT data in order to evaluate the accuracy (performance) of a produced realogram and to enable optimization of realogram production. It is noted that in certain situations, corresponding GT data for one or more of the realogram quality properties may not be available, for example due to a lack of sufficiently accurate data. Nevertheless, there may be advantages in evaluating realogram performance based on realogram quality properties for which there is no corresponding GT data. In such cases, the processing subsystem 50 (for example using the optimization module 68) may function to provide estimations of GT data values where GT data is not available. In the following description, the word ‘estimate’ is added at the end of the metrics where no GT data is available, for example, “placement location confidence ‘estimate’”, “category region confidence ‘estimate’”, etc. These estimates may be used for the selection step (executed, for example, by the selection module 67) and can be included in the generated realogram as well as used for on-going performance monitoring. The estimates are constructed as a function of the cluster statistics. For example, the placement confidence estimate is a function that takes the cluster statistics (number of scans, scan median accuracy, average scanning rate, etc.) and outputs a probability metric. More specifically, the placement location confidence estimate, p^{L}, may be of the form p^{L}=2^{-(α+βN)}, where Nis the number of scans in the cluster and α and β are positive optimization parameters. Thus, the more scans in the cluster the higher its location confidence.

Similarly, the recency confidence estimate, p^{R}, may be of the form

$${p}^{R} = {2}^{- {( \frac{Δ T}{α T + b} )}^{2}} ,$$

where ΔT is the time difference between current time and last scan in cluster time, T is the average time difference between scans in the cluster, and a and b are optimization parameters.

The placement confidence estimate, p^{C}, may take the form of the multiplication of the placement location confidence estimate and the recency confidence estimate two, i.e., p^{C}=p^{L}p^{R}.

Similar functions can be constructed for the other performance metric estimates.

For optimization, the optimization module 68 may consider several cost functions. For simplicity of presentation, only mean-square error (MSE) loss over some of the metrics is considered in the following example:

$$placement cost = {‖ \frac{{N}_{lp} - {N}_{p}}{{N}_{l p}} ‖}^{2} + \frac{1}{M} {\sum }_{m} ( {‖ {x}_{m}^{e s t} - {x}_{m}^{G T} ‖}^{2} + {‖ {p}_{m}^{L} - 1 ( Δ {x}_{m} < 3 ) ‖}^{2} )$$

In the example, Nₗₚ is the number of unique products learned, Nₚ is the number of unique products in the scan-location data set, the average is performed over the resulting method placements, the first term is the location error Δx, and the last term is location confidence estimation error where the function I(*) is the indicator function which takes the value 1 if the location error is below 3 meters and 0 otherwise.

In certain embodiments, tweaking optimization may be considered or a full machine learning (ML) optimization with a known ML framework, such as Pytorch or Tensorflow, can be used. Additionally, different weights for each term may also be considered to adjust for different optimization targets. For example, the weight of the first term may be increased if coverage is of greater importance than accuracy, or the weight of the last term may be increased if the estimation of confidence is also of importance.

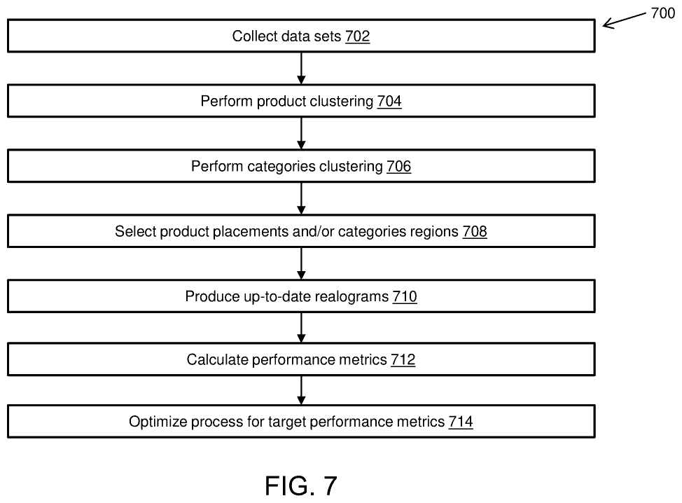

With continued reference to FIGS. 1-6, refer now to FIG. 7, which shows a flow diagram detailing a computer-implemented process 700 in accordance with embodiments of the disclosed subject matter. The computer-implemented process 700 includes an algorithm for, among other things, producing up-to-date realograms for various products of a store. The process and sub-processes of FIG. 7 are computerized (i.e., computer-implemented) processes performed by the system 10, including, for example, the mobile devices 12, the IPS 30, the scan-location association module 26, and the processing subsystem 50 including the CPU 52 and associated components, including the pre-filtering module 62, the cluster module 63, the post-processing module 64, the confidence module 65, the realogram module 66, the selection module 67, and the optimization module 68. The aforementioned process and sub-processes are for example, performed automatically, but can be, for example performed manually, and are performed, for example, in real time.

The process 700 is effectively a combination of the processes described with reference to FIGS. 3-5, and further including steps for selection and optimization.

The process 700 begins at step 702, where scan-location data sets are collected by the system 10. Steps 302-308 of FIG. 3 can be considered as the subs-steps for performing step 702.

At step 704, product clustering is performed. Steps 402-408 of FIG. 4 can be considered as the subs-steps for performing step 704.

At step 706, categories clustering is performed. Steps 502-508 of FIG. 5 can be considered as the subs-steps for performing step 706.

At step 708, the system 10, for example the selection module 67, processes the realogram data outputs from steps 704 and 706 to select product placements and/or categories regions, and then at step 710 the up-to-date realograms are generated by, for example, the realogram module 66.

Steps 712 and 714 relate to optional optimization steps. At optional step 712, the system 10, for example the optimization module 68, calculates performance metrics to be used for optimization, and at step 714 the optimization module 68 optimizes the overall realogram generation process for target performance metrics (optimization targets), for example depending on use case.

In certain embodiments, instead of using confidence as the basis for selection, optimization or performance metric calculation, other metrics, such as the defined location accuracy, can be used.

In certain embodiments, each of the mobile devices 12 may further include a user product-not-there check module, which although not shown in the drawings can be part of a scanning application that is part of or otherwise associated with the scan module 22. The product-not-there check module can allow users of the mobile devices to provide feedback to the system 10 to allow the system 10 unlearn product placements in the realogram faster, for example by reducing the recency confidence faster, or for example unlearning an already learned placement location if at least a certain number of product-not-there checks were made in the vicinity of a learned product placement.

Implementation of the method and/or system of embodiments of the disclosure can involve performing or completing selected tasks manually, automatically, or a combination thereof. Moreover, according to actual instrumentation and equipment of embodiments of the method and/or system of the disclosed subject matter, several selected tasks could be implemented by hardware, by software or by firmware or by a combination thereof using an operating system.

For example, hardware for performing selected tasks according to embodiments of the disclosure could be implemented as a chip or a circuit. As software, selected tasks according to embodiments of the disclosed subject matter could be implemented as a plurality of software instructions being executed by a computer using any suitable operating system. In an exemplary embodiment of the disclosure, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present disclosure. A non-transitory computer readable (storage) medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

The above-described methods including portions thereof can be performed by software, hardware, and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The methods and systems, including components thereof, herein have been described with exemplary reference to specific hardware and software. The methods have been described as exemplary, whereby specific steps and their order can be omitted and/or changed by persons of ordinary skill in the art to reduce these embodiments to practice without undue experimentation. The methods and systems have been described in a manner sufficient to enable persons of ordinary skill in the art to readily adapt other hardware and software as may be needed to reduce any of the embodiments to practice without undue experimentation and using conventional techniques.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the disclosure.

Although the disclosed subject matter has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A method, comprising:
receiving, for each mobile device of one or more mobile device, scan-location data that includes product scan data and associated location data for the mobile device, wherein the product scan data is generated in response to scanning of a product by the mobile device and the location data is indicative of a location of the mobile device at a time of the scanning of the product; and
processing the scan-location data of the one or more mobile device to produce a realogram of products scanned by the one or more mobile device.

2. The method of claim 1, wherein the processing the scan-location data includes:
filtering the scan-location data of the one or more mobile device to produce filtered scan-location data sets, and
for each product in the filtered scan-location data sets, performing a clustering algorithm to produce a product cluster data set that includes a cluster of product placement locations descriptive of potential product locations associated with the product,
wherein the realogram of the products scanned by the one or more mobile device is produced based at least in part on the product cluster data sets.

3. The method of claim 2, wherein filtering the scan-location data includes filtering out data based on one or more of: time of the scanning of the product, accuracy of the location data, a vicinity of the location indicated by the location data to a store containing the product, consistency of accuracy of product scans by mobile devices, or presence of batch product scans.

4. The method of claim 2, wherein the clustering algorithm produces a number of clusters that is unknown prior to execution of the clustering algorithm.

5. The method of claim 2, wherein the clustering algorithm is an algorithm based on one or more of the following algorithms: ordering points to identify clustering structure (OPTICS) algorithm, density-based spatial clustering of applications with noise (DBSCAN) algorithm, affinity propagation, and mean-shift.

6. The method of claim 2, wherein the clustering algorithm produces the product cluster data based on time data and location data.

7. The method of claim 2, wherein the processing the scan-location data further includes:
post-processing the product cluster data sets to produce post-processed product cluster data sets, and
estimating, for each product in the post-processed product cluster data sets, a placement location confidence indicative of a confidence of locating the product in each potential product location,
wherein the realogram of the products scanned by the one or more mobile device is produced based at least in part on the post-processed product cluster data sets and the estimated placement location confidence.

8. The method of claim 7, wherein the estimated placement location confidence includes an estimated recency confidence indicative of a confidence, for each potential product location, that the product is still located at the potential product location.

9. The method of claim 8, wherein the estimated placement location confidence for each product is a function of the post-processed product cluster data sets.

10. The method of claim 8, wherein the product in each product cluster data belongs to one or more category, the method further comprising:
receiving input data derived from the product cluster data sets;
filtering the input data to produce filtered data;
for each category in the filtered data, performing a clustering algorithm to produce a category cluster data set that includes a cluster of product placement locations descriptive of potential product locations of different products belonging to a common category;
post-processing the category cluster data sets to produce post-processed category cluster data sets; and
estimating, for each category in the post-processed category cluster data sets, a second placement location confidence indicative of a confidence of locating a product that belongs to the category in each potential product location,
wherein the realogram of the products scanned by the one or more mobile device is produced further based in part on the post-processed category cluster data sets and the estimated second placement location confidence.

11. The method of claim 10, wherein the input data derived from the product cluster data sets is the product cluster data.

12. The method of claim 10, wherein the input data derived from the product cluster data sets includes the post-processed product cluster data sets and the estimated placement location confidence.

13. The method of claim 1, wherein the method is optimized based on ground truth data that is based on at least one of: i) on actual in-store placement of products, or ii) high-confidence estimates of placement locations of products in the produced realogram.

14-16. (canceled)

17. A system, comprising:
a non-transitory computer readable storage media that stores program code; and
a processor in communication with the non-transitory computer readable storage medium, the processor configured to execute the program code to:
receive, for each mobile device of one or more mobile device, scan-location data that includes product scan data and associated location data for the mobile device, wherein the product scan data is generated in response to scanning of a product by the mobile device and the location data is indicative of a location of the mobile device at a time of the scanning of the product, and
process the scan-location data of the one or more mobile device to produce a realogram of products scanned by the one or more mobile device.

18. The system of claim 17, wherein the processor is configured to execute the program code to process the scan-location data of the one or more mobile device to produce a realogram for each product by:
filtering the scan-location data of the one or more mobile device to produce filtered scan-location data sets, and
for each product in the filtered scan-location data sets, performing a clustering algorithm to produce a product cluster data set that includes a cluster of product placement locations descriptive of potential product locations associated with the product,
wherein the realogram of the products scanned by the one or more mobile device is produced based at least in part on the product cluster data sets.

19. The system of claim 18, wherein the processor is further configured to execute the program code to process the scan-location data of the one or more mobile device to produce a realogram for each product by:
post-processing the product cluster data sets to produce post-processed product cluster data sets, and
estimating, for each product in the post-processed product cluster data sets, a placement location confidence indicative of a confidence of locating the product in each potential product location,
wherein the realogram of the products scanned by the one or more mobile device is produced based at least in part on the post-processed product cluster data sets and the estimated placement location confidence.

20. The system of claim 19, wherein the product in each product cluster data belongs to one or more category, and wherein the processor is further configured to execute the program code to:
receive input data derived from the product cluster data sets,
filter the input data to produce filtered data,
for each category in the filtered data, perform a clustering algorithm to produce a category cluster data set that includes a cluster of product placement locations descriptive of potential product locations of different products belonging to a common category,
post-process the category cluster data sets to produce post-processed category cluster data sets, and
estimate, for each category in the post-processed category cluster data sets, a second placement location confidence indicative of a confidence of locating a product that belongs to the category in each potential product location,
mobile device is produced further based in part on the post-processed category cluster data sets and the estimated second placement location confidence.

21. The system of claim 20, wherein the input data derived from the product cluster data sets is the product cluster data.

22. The system of claim 20, wherein the input data derived from the product cluster data sets includes the post-processed product cluster data sets and the estimated placement location confidence.

23. The system of claim 17, further comprising: an indoor positioning system (IPS) in communication with each mobile of device of the one or more mobile device, the IPS configured to determine, for each mobile device, a location of the mobile device based at least in part on sensor data received from one or more sensor of the mobile device.
